(19) United States
(12) Patent Application Publication
(10) Pub. No.: US 2017/0301333 A1
(43) Pub. Date: Oct. 19, 2017

(54) Invention of a Marine Seismic Airgun Pulse Amplifier Cone

(71) Applicant: Michael Patrick West, Windsor (CA)

(72) Inventor: Michael Patrick West, Windsor (CA)

(21) Appl. No.: 15/099,875

(22) Filed: Apr. 15, 2016

(51) Int. Cl. G10K 11/08; G01V 1/38; G01V 1/137

(52) U.S. Cl. CPC G10K 11/08; G01V 1/137; G01V 1/3808

(57) ABSTRACT

Marine seismic data recording employs airgun sources which are usually arrays of airguns of various sizes towed behind a seismic vessel. The seismic airgun pulses are omni-directional except for some cancellation of horizontal waves by the geometry of the array. The Airgun Pulse Amplifier Cone is an invention that can be used with a commercially available airgun mounted at or near the top of the cone which will increase the amplitude of the down-going pulses and reduce the amplitude of the horizontally traveling pulses. Multiple airgun cones can be constructed into a steel box-structure for towing, to provide the tuning benefits of airgun arrays and the box itself. Using the Airgun Pulse Amplifier Cone can reduce the impact on marine life and the environment near a seismic survey and can also result in lower airgun volume requirements and lower airgun costs.

### CROSS-REFERENCE TO RELATED APPLICATIONS

Not Applicable

### STATEMENT REGARDING FEDERALLY SPONSORED RESEARCH AND DEVELOPMENT

Not Applicable

### INCORPORATION-BY-REFERENCE OF MATERIAL SUBMITTED ON A COMPACT DISC

Not Applicable

### BACKGROUND OF THE INVENTION

### 1. Field of the Invention

The field of the invention is marine seismic data acquisition, wherein seismic data are acquired for the purpose of analyzing the sea-bed and/or geologic strata below, to depths of several kilometers.

### 2. Background Art

Seismic (low-frequency sonic) data acquisition methods employ airgun sources in marine environments for oil and gas exploration and other seismic imaging purposes. These marine airguns are usually stainless steel tubes that store and release high pressure air through a set of small ports when triggered as discussed U.S. Pat. No. 4,472,794 to Chelminski. The airguns are usually deployed in a set or geometric array on a frame or towed behind a vessel with flotation tubes. The airguns are immersed directly in the water and the seismic impulses that are generated, emanate in all directions (ie: an omni-directional source) and large air bubbles also oscillate on their way to the surface of the water. When properly designed, the airgun array produces seismic impulses in the downward direction with enough amplitude and frequency bandwidth, to penetrate the water-bottom and sub-surface layers and reflect back to the seismic receivers towed in a neoprene streamer or in receiver nodes on the water bottom. In this fashion the seismic data are repeatedly or constantly recorded in order to build up a profile or three-dimensional image of the subsurface layers. The airgun sources must be fired repeatedly and possibly as often as every 10 to 15 seconds during the seismic data acquisition process. The seismic impulses that travel horizontally through the water column disturb marine life including whales and reefs. This is a concern in some areas of the oceans.

### REFERENCES

Waters, K H. (1981), Reflection Seismology, a Tool for Energy Resource Exploration, John Wiley and Sons, New York

Dobrin, M. B., (1980), Introduction to Geophysical Prospecting. Milton B. Dobrin, McGraw-Hill, New York

### BRIEF SUMMARY OF THE INVENTION

A cone of appropriate size, constructed of thick steel or any appropriate material, and with slanted, sloped or curved inner surface, can be used as a device to direct the seismic pulses from a seismic airgun, downwards into the subsurface geology for seismic imaging. (FIG. 1.) The seismic airgun is mounted at the top of the cone opening. A plurality of cones with airguns can be used in any type of spatial array. Cones can also be incorporated into a thick steel box with multiple cones and airguns to create a fixed array system with hydro-dynamic shape to reduce drag and noise, that is towed under the water's surface by a marine vessel. (FIG. 2.)

Use of the Marine Seismic Pulse Amplifier Cone will increase the amplitude of the down-going seismic impulses created by the airgun or array of airguns during marine seismic data recording. The net effect will also include a reduction in the amplitude of the horizontally-traveling impulses that can cause damage to marine life and reefs in shallow-water areas. Use of the Amplifier Cone can also result in a reduction in the number of airguns required in an array for a given down-going sound-pressure level, and therefore a reduction in airgun costs.

### BRIEF DESCRIPTION OF DRAWINGS

FIG. 1: a diagram of a single Marine Seismic Airgun Pulse Amplifier Cone deployed with an airgun, hanging on chains; both side and end views.

FIG. 2: a diagram of multiple Marine Seismic Airgun Pulse Amplifier Cones deployed with airguns, constructed into a box structure, with hydro-dynamic shape, towing behind a marine seismic vessel.

### DETAILED DESCRIPTION OF THE INVENTION

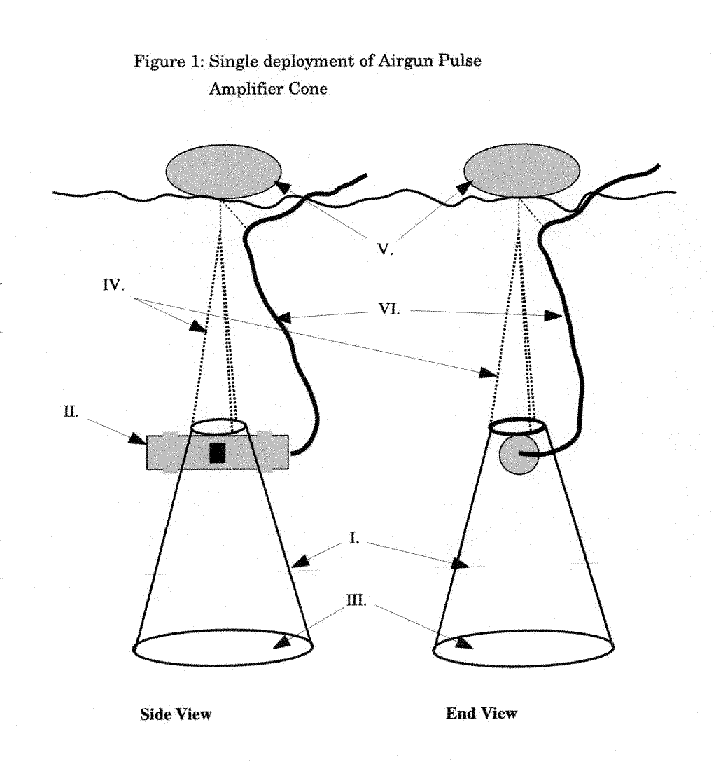

The Airgun Pulse Amplifier Cone (FIG. 1, element I.) will direct the pulses from the seismic airgun (FIG. 1, element II.) that is mounted near the top of the cone, through the open bottom of the cone (FIG. 1, element III.) in a downward direction. The cone and airgun are suspended in the water from chains (FIG. 1, element IV.) using a flotation device (FIG. 1, element V.) Air hoses supply compressed air to the airgun to create the impulses. (FIG. 1, element VI.)

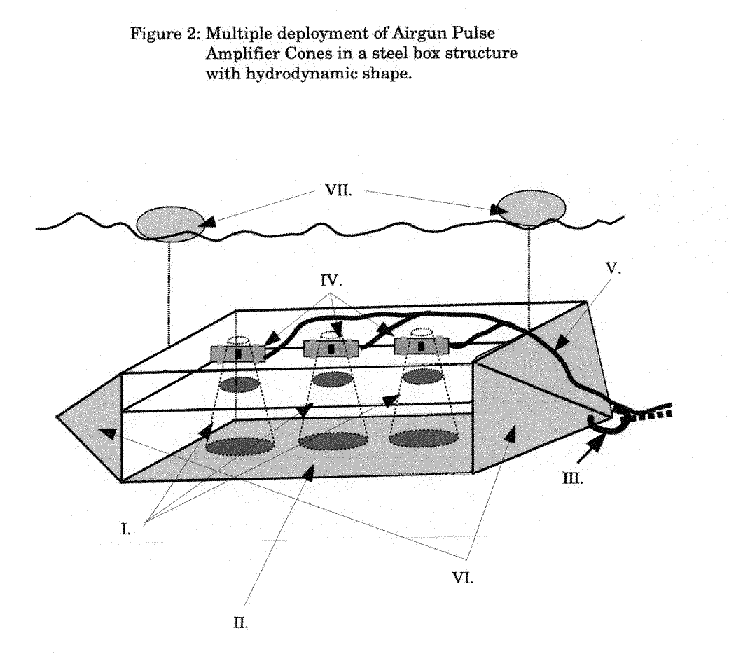

A plurality of Airgun Pulse Amplifier Cones (FIG. 2, element I.) can be created in a structured array, either hanging on chains (for a stationary array) or in a box-structure (FIG. 2, element II.) made of steel or any appropriate material, for towing by means of a tow bracket. (FIG. 2, element III.) Airguns (FIG. 2, element IV.) are mounted at the top of each of the plurality of cones and are operated using using air hoses (FIG. 2, element V.). The box-structure for the plurality of Airgun Pulse Amplifier Cones has a hydro-dynamic shape (FIG. 2, element VI.) to reduce tow-noise and is suspended from flotation devices (FIG. 2, element VII.).

Single or multiple Airgun Pulse Amplifier Cones can be deployed in this way, either suspended on chains from flotation devices, or integrated into a box structure for under-water towing of airgun arrays with amplifier cones.

1. The invention of the Airgun Pulse Amplifier Cone that increases the amplitude of the seismic pulses in the downward direction, from a seismic airgun mounted at or near to the top of the cone, while reducing the amplitude of the pulses in the horizontal direction.

2. The invention of claim 1 made from steel or any appropriate material of any thickness and made to any dimensions required to optimize performance of the Airgun Pulse Amplifier Cone.

3. The invention of claim 1 with the inner surface of the cone having any slope or angle to the vertical, or having any curvature of the inner surface of the cone.

4. The invention of claim 1 with the airgun mounted in any position or configuration within or attached to the Airgun Pulse Amplifier Cone.

5. The invention of claim 1 wherein a plurality Airgun Pulse Amplifier Cones with airguns mounted on them, can be hung from flotation devices on a frame or on chains to create an array of cones and airguns.

6. The invention of claim 1 wherein a plurality of Airgun Pulse Amplifier Cones with airguns mounted on them, can be constructed in a box made of steel or any other appropriate material of any thickness, that is hung from flotation devices and towed behind a seismic vessel. The Airgun Pulse Amplifier Cones within the box can be at any position relative to each other and the box, for purposes of desired airgun array response. The box or structure for creating the array can be of any size required and have a hydro-dynamic shape to reduce drag and noise when being towed.
